(19) United States
(12) Patent Application Publication
(10) Pub. No.: US 2009/0164623 A1
(43) Pub. Date: Jun. 25, 2009

(54) METHODS AND SYSTEMS FOR TRACKING EVENT LOSS

(76) Inventors: Akon Dey, Sunnyvale, CA (US); Guru Golani, Sunnyvale, CA (US); Waqar Hasan, Cupertino, CA (US); Krishna Ramachandran, Sunnyvale, CA (US); Neel Madhav, Palo Alto, CA (US); Raghotham S. Murthy, Palo Alto, CA (US); Vijay Raghunathan, San Francisco, CA (US); Praveen Sadhu, Sunnyvale, CA (US); Partha Saha, Oakland, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 11/961,297

(22) Filed: Dec. 20, 2007

(51) Int. Cl. G06F 15/173

(52) U.S. Cl. 709/224

(57) ABSTRACT

Systems and methods for tracking event loss are set forth in this disclosure. More specifically, systems and methods for tracking event loss within a first time period and second time period are set forth in this disclosure.

### BACKGROUND

Increasingly, an abundance of business intelligence data is gathered from the Internet and other information sources. Much of this data takes the form of information describing an action or occurrence (i.e., an event) that is typically generated by a user or a computer. Event data, including but not limited to data that may be associated with or derived from events, is often logged or stored for later access, identification, manipulation, or processing.

In the case of Internet event data, web servers typically stream a log of event data to one or more computers that in turn often store, modify or forward the event data to other places in a network. Advanced networks today comprise thousands of web servers that may be located in different geographic regions and collectively may process billions of events per day. In such a massive system, the loss of even a small portion of event data becomes difficult to track and may result in reporting errors. Loss of event data may occur for a variety of reasons. For example, event loss may result from irregularities in data triggering (e.g., triggered events may be reported from a computer with an inaccurate clock), network congestion (e.g., network resources inundated with too many requests may delay or prohibit transmission of certain event data), acts of God (e.g., floods and power outages), and/or human error (e.g., improper configuration of servers or other network components).

Currently, event loss is typically discovered through a brute-force examination of event transmission information. Tracking down errors in such massive computing networks may require hundreds of hours of time.

### SUMMARY

Disclosed herein are systems and methods that have been developed for tracking event loss. In one embodiment (which embodiment is intended to be illustrative and not restrictive), a method for tracking event loss is provided. The method includes receiving, by a cluster of first-level managers, first reported attributes of event data that are transmitted to one or more first-level collectors within a first time period. The method further includes receiving, by the cluster of first-level managers, second reported attributes of the event data that is received by the one or more first-level collectors within the first time period. The method yet further includes, after the first time period, comparing, by the cluster of first-level managers, an aggregate of the first reported attributes to an aggregate of the second reported attributes.

By comparing we refer to the act of checking equality of aggregated results based on the reported attributes. The attributes include, but are not limited to, the number of events in the first time period. The cluster administered via cluster managers refer to a set of machines physically co-located and possibly on a shared computer network, where some of the machines act as transmitters and others as collectors of data.

In one aspect of the method, the step of comparing includes checking the equality of the aggregate of the first reported attributes to the aggregate of the second reported attributes. In another aspect of the method, the first reported attributes are the number of individual events received by the one or more first-level collectors within the first time period. In yet another aspect, the method includes, based on the results of the comparing, generating a first-level error message upon determining by the cluster of first-level managers that the aggregate of the first reported attributes does not equal the aggregate of the second reported attributes. In still another aspect of the method, generating the first-level error message further includes identifying a localized region corresponding to the one or more first-level collectors. In another aspect, the method includes, based on the results of the comparing, transmitting the event data that is received by the one or more first-level collectors to one or more second-level collectors upon determining by the cluster of first-level managers that the aggregate of the first reported attributes equals the aggregate of the second reported attributes. In yet another aspect of the method, the event data transmitted to the one or more second-level collectors comprises at least a file or a container that contains event data for a plurality of events. In still another aspect of the method, the second-level collectors are fewer in number than the first-level collectors. In yet another aspect of the method, at least one second-level collector receives event data from a plurality of the first-level collectors. In still another aspect, the method includes receiving, by a cluster of second-level managers, third reported attributes of event data that are transmitted to the one or more second-level collectors within a second time period. In another aspect, the method includes, after the second time period, comparing by the cluster of second-level managers, an aggregate of the third reported attributes to an aggregate of the fourth reported attributes. In yet another aspect, the method includes, based on the results of the comparing, generating a second-level error message upon determining by the cluster of second-level managers that the aggregate of the third reported attributes do not equal the aggregate of the fourth reported attributes. In still another aspect of the method, generating the second-level error message further includes identifying a localized region corresponding to the one or more second-level collectors. In another aspect, the method includes, based on the results of the comparing, transmitting the event data that is received by the one or more second-level collectors to a data warehouse upon determining by the cluster of second-level managers that the aggregate of the third reported attributes equals the aggregate of the fourth reported attributes. In yet another aspect of the method, the second time period comprises a plurality of the first time periods. In another aspect of the method, the first time period is sufficient to calculate the aggregate of the third reported attributes and the aggregate of the fourth reported attributes. In yet another aspect of the method, the first time period is sufficient to calculate the aggregate of the first reported attributes and the aggregate of the second reported attributes.

As another example (which embodiment is intended to be illustrative and not restrictive), a system for tracking event loss is provided. The system includes one or more event generators that transmit event data corresponding to a plurality of events within a first time period and that report attributes of the event data transmitted within the first time period. The system further includes one or more first-level collectors that receive the transmitted event data within the first time period and report attributes of the event data received within the first time period. The system yet further includes a cluster of first-level managers that compare the attributes of the event data transmitted within the first time period and the attributes of the event data received within the first time period, and based upon the comparison, signal transmission of the event data by the one or more first-level collectors.

In one aspect of the system, at least one of the cluster of first-level managers compares the attributes of the event data and at least one of the cluster of first-level collectors transmits the event data. In another aspect, the system includes one or more second-level collectors that receive event data transmitted by the one or more first-level collectors within a second time period and report attributes of the event data transmitted by the one or more first-level collectors within the second time period. In yet another aspect, the system includes a cluster of second-level managers that compare the attributes of the event data transmitted within the second time period and the attributes of the event data received within the second time period, and based upon the comparison, signal transmission of the event data to a data warehouse by the one or more second-level collectors. In still another aspect of the system, at least one of the cluster of second-level managers compares the attributes of the event data and at least one of the cluster of second-level collectors transmits the event data. In another aspect of the system, the cluster of second-level managers receive attributes of the event data from the cluster of first-level managers. In yet another aspect of the system, the first-level managers and the second-level managers communicate via a shared network. In still another aspect of the system, the first-level managers and the second-level managers are physically co-located.

These and various other features as well as advantages will be apparent from a reading of the following detailed description and a review of the associated drawings. Additional features are set forth in the description which follows, and in part will be apparent from the description, or may be learned by practice of the described embodiments. While it is to be understood that both the foregoing general description and the following detailed description are exemplary and explanatory, the benefits and features will be realized and attained by the structure particularly pointed out in the written description and claims hereof as well as the appended drawings.

### BRIEF DESCRIPTION OF THE DRAWINGS

The following drawing figures, which form a part of this application, are illustrative of embodiments systems and methods described below and are not meant to limit the scope of this disclosure in any manner, which scope shall be based on the claims appended hereto.

FIG. 1 illustrates an embodiment of a system for tracking event loss.

FIG. 2 illustrates another embodiment of a system for tracking event loss.

FIG. 3 illustrates an embodiment of a method for tracking event loss.

### DETAILED DESCRIPTION

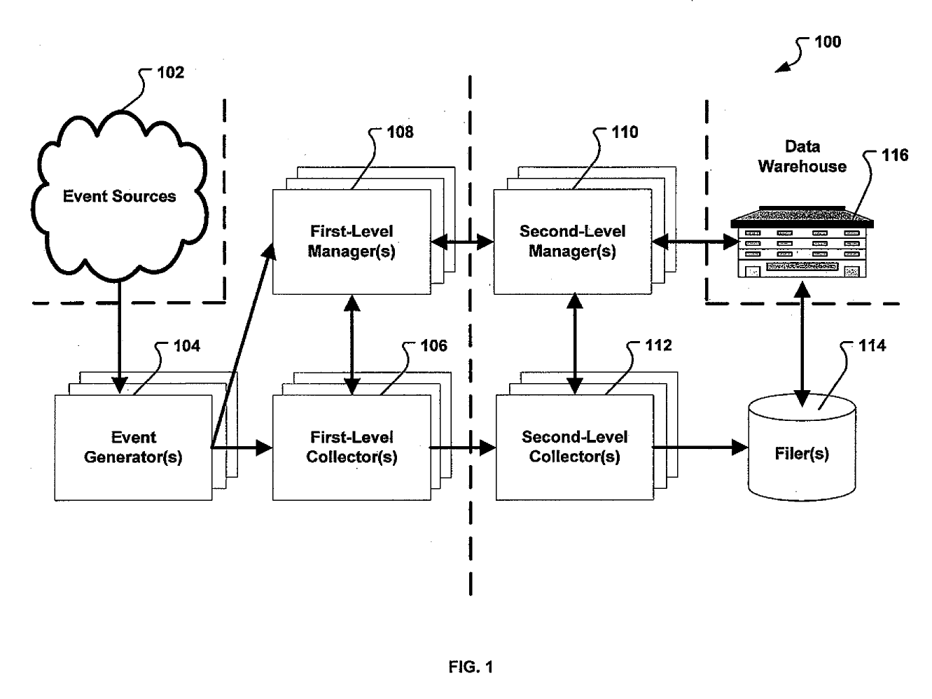

FIG. 1 illustrates an embodiment of a system 100 for tracking event loss. In one embodiment of system 100, one or more event generators 104 transmit event data corresponding to a plurality of events within a first time period and that report attributes of the event data transmitted within the first time period. As used within this disclosure, the associated figures, and the appended claims, “event data” is used generally to describe one or more items of information. One skilled in the art will recognize that an event typically comprises an action or occurrence to which a program might respond. For example, user-generated events may include key presses, button clicks, or mouse movements. As another example, events may take other forms including, but not limited to, an occurrence generated by a computer or an occurrence to which a computer might respond, a processing event, or an event based upon temporal or spatial information. As used within this disclosure, the associated figures, and the appended claims, event data may be compiled or collected from one or more computers that may be connected via a network. Event data may be logged. Event data may describe items of information within a stream of events. For example event data may include, but is not limited to, Internet data that may be collected from end-users who interact with Internet web pages and other information resources. Event data may originate from an event source 102. For example, event data may originate from one or more web-servers.

Additionally, as used within this disclosure, the associated figures, and the appended claims, “hierarchically-arranged” is used generally to describe a type of organization that, like a tree, branches into more specific units or leaves, each of which correspond to the higher-level unit immediately above. For example, as set forth in this disclosure, a group of hierarchically-arranged first-level collectors may be substantially larger (e.g., in a ratio exceeding 5:1) than the group of hierarchically-arranged second-level collectors. Thus, following this example, the second-level collectors would occupy a branch position higher to the root or parent unit of the tree than would the first-level collectors occupying a leaf position.

Further, as used within this disclosure, the associated figures, and the appended claims, “attribute” is used generally to describe information that characterizes or otherwise describes event data. For example, attributes may include, but are not limited to, the number of events received and/or transmitted within a certain time period.

In an embodiment of system 100, system 100 further includes one or more first-level collectors 106 that receive the event data transmitted by event generators 104 within the first time period and report attributes of the received event data within the first time period. In a further embodiment of system 100, a cluster of first-level managers 108 compare the attributes of the event data transmitted within the first time period and the attributes of the event data received within the first time period, and based upon the comparison, signal transmission of the event data by the one or more first-level collectors 106. In one aspect of the system 100, at least one of the cluster of first-level managers compares the attributes of the event data and at least one of the cluster of first-level collectors transmits the event data. For example, some first-level managers act as transmitters and others as collectors of event data.

In another embodiment, the system 100 may further comprise one or more second-level collectors 112 that receive the event data transmitted by the one or more first-level collectors 106 within a second time period and report attributes of the received event data transmitted by the one or more first-level collectors 106 within a second time period. In this embodiment, a cluster of second-level managers 1 10 compare the attributes of the event data transmitted within the second time period and the attributes of the event data received within the second time period, and based upon the comparison, signal transmission of the event data to a data warehouse 116 by the one or more second-level collectors 112. Thus, in one aspect of the system 100, at least one of the cluster of second-level managers compares the attributes of the event data and at least a second of the cluster of second-level managers signals transmission of the event data. In an embodiment, one or more filers or filing processes 114 may help signal transmission of event data to the data warehouse 116 from the one or more second-level collectors 112. For example, a filing process 114 may periodically seek to move event data from the second event collector and transmit the event data to the data warehouse 116.

In a further embodiment of system 100, the cluster of second-level managers 110 may communicate with the one or more first-level collectors 106. For example, the cluster of second-level managers 110 may receive transmission information from the one or more first-level collectors 106. In yet another embodiment, the cluster of second-level managers 110 may communicate (e.g., via a shared network) with the cluster of first-level managers 108. For example, the cluster of second-level managers 110 may communicate via a network to the cluster of first-level managers 108 whereby information regarding event data may be transmitted between both sources. In another embodiment, a cluster of first-level managers 108 may reside on a first computing device and a cluster of second-level managers 110 may reside on a second computing device, wherein the first computing device and a second computing device communicate via a network. In yet another embodiment, the first-level managers and the second-level managers may be physically co-located (e.g., residing at a common geographic location, a common network location, etc.).

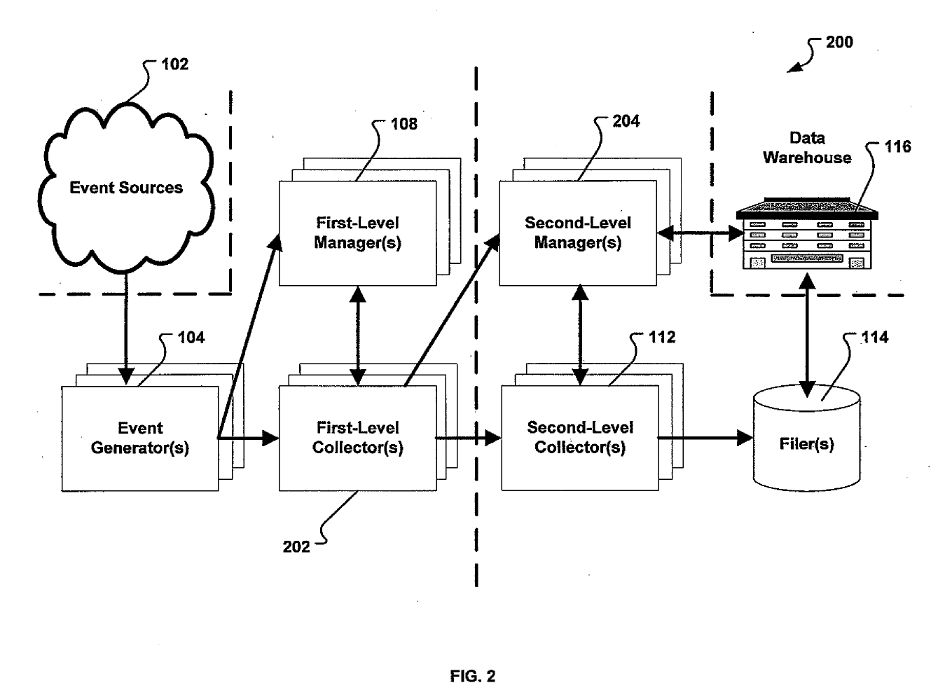

FIG. 2 illustrates another embodiment of a system 200 for tracking event loss. In one embodiment of the system 200, one or more first-level collectors 202 compare attributes of the transmitted event data within a first time period with attributes of the received event data within the first time period. In this embodiment, the one or more first-level collectors 202, based upon a determination that the first attribute(s) equal the second attribute(s), signal transmission of the event data by the one or more first-level collectors 202. As illustrated by this embodiment, the one or more hierarchically-arranged first-level collectors may confirm or signal transmission of the event data by communicating with a cluster of second-level managers 204.

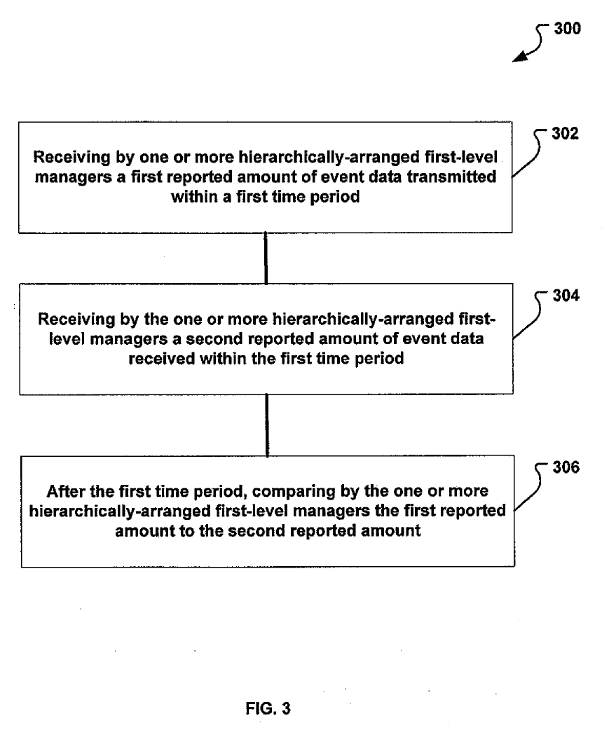

FIG. 3 illustrates an embodiment of a method 300 for tracking event loss. In the method 300, a cluster of first-level managers receives first reported attributes of event data that are transmitted to one or more first-level collectors within a first time period in a receiving operation 302. One skilled in the art will recognize that first reported attributes may take many forms, including but not limited to a real-time total or a total time aggregated over a period of time. As discussed previously, event data may take many forms. Thus, one skilled in the art will recognize that event data may include, but is not limited to, information describing an action or occurrence (i.e., an event) that is typically generated by a user or a computer. For example, in the case of Internet event data, event data may include information describing navigation to and from web pages, user-interactions with web pages, user data (e.g., name, e-mail address), etc. In the method 300, the cluster of first-level managers then receives a second reported attributes of event data that are received by the one or more first-level collectors within the first the period in receiving operation 304. For example, a first time period may comprise a period of seconds. As another example, a first time period may be defined in terms of (i.e., by counting) a total number of individual events received. In the method 300, after the first time period, the cluster of first-level managers then compare an aggregate of the first reported attributes to an aggregate of the second reported attributes in a comparing operation 306. For example, the cluster of first-level managers may compare the first reported attributes for a first time period to the second reported attributes for the first time period. One skilled in the art will recognize that a comparing operation 306 may utilize one or more computing devices with one or more processors. One skilled in the art will also recognize that comparing may take many forms, including but not limited to, checking words, files, or numeric values to determine whether they are the same or different.

In another embodiment, the method 300 further comprises checking the equality of the aggregate of the first reported attributes to the aggregate of the second reported attributes. In another embodiment of the method 300, the first reported attributes are the number of events received by the one or more first-level collectors within the first time period.

In another embodiment, the method 300 further comprises, based on the results of the comparing operation 306, generating a first-level error message upon determining by the cluster of first-level managers that the aggregate of the first reported attributes do not equal the aggregate of the second reported attributes. An error message may take many forms, including but not limited to generation and transmission of a signal (e.g., transmitting an error notification packet), firing of a “data loss” event (e.g., throwing a data loss exception), or otherwise notifying a person or computer that an error occurred. In one embodiment, generating the first-level error message may comprise identifying the one or more first-level collectors based upon a hierarchical arrangement. For example, to determine the source of an error, the generated error message may identify one or more of the first-level collectors that reported the attributes leading to generation of the error message. In another embodiment of the method 300, generating the first-level error message further comprises identifying the location of the one or more first-level collectors or a localized region corresponding to the one or more first-level collectors. For example, the first-level collectors may be located at geographically remote locations around the world such that an error-message needs to be pin-pointed to a certain geographic region and/or computing device at the location.

In yet another embodiment, the method 300 further comprises, based on the results of the comparing operation 306, transmitting the event data that is received by the one or more first-level collectors to one or more second-level collectors upon determining by the cluster of first-level managers that the aggregate of the first reported attributes equals the aggregate of the second reported attributes. Event collectors and the cluster of first-level managers may be distributed (e.g., spread across geographically disparate regions) in a redundant manner so to avoid data loss and transmission irregularities. In another embodiment of the method 300, the event data transmitted to the one or more second-level collectors comprises at least one file containing event data for a plurality of events. In another embodiment of the method 300, the event data transmitted to the one or more second-level collectors comprises at least one data structure (i.e., an organizational structure) or container containing event data for a plurality of events.

In another embodiment, the method 300 further comprises, receiving, by a cluster of second-level managers, third reported attributes of event data that are transmitted to one or more second-level collectors within a second time period; receiving by the cluster of second-level managers a fourth reported attributes of event data that are received by the one or more second-level collectors within the second time period; and, after the second time period, comparing by the cluster of second-level managers, an aggregate of the third reported attributes to an aggregate of the fourth reported attributes. In yet another embodiment, the method 300 further comprises, based on the results of the comparing by the cluster of second-level managers, generating a second-level error message upon determining by the cluster of second-level managers that the aggregate of the third reported attributes do not equal the aggregate of the fourth reported attributes. In one embodiment, generating the second-level error message further comprises identifying the location of the one or more second-level collectors. In another embodiment, the method 300 further comprises, based on the results of the comparing by the cluster of second-level managers, transmitting the event data that is received by the one or more second-level collectors to a data warehouse upon determining by the cluster of second-level managers that the aggregate of the third reported attributes equals the aggregate of the fourth reported attributes. For example, transmission of the received event data may occur where comparing by the cluster of second-level managers results in a “close-of-books” determination for a certain time period (e.g., measured in milliseconds, seconds, minutes, hours, and/or days). In yet another embodiment of method 300, the second time period comprises a plurality of the first time periods. For example, the first time period may correspond to hourly time periods, whereas the second time period may correspond to a time period lasting a day or longer. One skilled in the art will recognize that many permutations of a first time period and a second time period are possible and within the scope of this disclosure. In another embodiment of method 300, the first-level collectors outnumber the second-level collectors. For example, in a large distributed network, the ratio of first-level collectors to second-level collectors may be 100:1 or greater. In yet another embodiment of method 300, a plurality of the first-level collectors transmits the event data to one second-level collector. In still another embodiment of method 300, at least one hierarchically-arranged second-level collector receives event data from a plurality of hierarchically-arranged first-level event collectors. In one embodiment, the second-level collectors may be fewer in number than the first-level collectors. In yet another embodiment, the second time period may comprise a plurality of the first time periods and/or may be a period that is sufficient to calculate the respective aggregate of reported attributes for comparison (e.g., the first and second reported attributes and the third and fourth reported attributes).

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of this disclosure. For example, upon detection of an error, one or more hierarchically-arranged first-level managers, hierarchically-arranged second-level managers, hierarchically-arranged first-level collectors and/or hierarchically-arranged second-level collectors may be notified about the error and report and/or transmit event data corresponding to the error to one or more computing devices.

Numerous other changes may be made which will readily suggest themselves to those skilled in the art and which are encompassed in the spirit of this disclosure and as defined in the appended claims.

What is claimed is:

1. A method for tracking event loss comprising:
receiving, by a cluster of first-level managers, first reported attributes of event data that are transmitted to one or more first-level collectors within a first time period;
receiving, by the cluster of first-level managers, second reported attributes of the event data that is received by the one or more first-level collectors within the first time period; and
after the first time period, comparing, by the cluster of first-level managers, an aggregate of the first reported attributes to an aggregate of the second reported attributes.

2. The method of claim 1 wherein the step of comparing comprises:
checking the equality of the aggregate of the first reported attributes to the aggregate of the second reported attributes.

3. The method of claim 1 wherein the first reported attributes are the number of individual events received by the one or more first-level collectors within the first time period.

4. The method of claim 1 further comprising:
based on the results of the comparing, generating a first-level error message upon determining by the cluster of first-level managers that the aggregate of the first reported attributes does not equal the aggregate of the second reported attributes.

5. The method of claim 4 wherein generating the first-level error message further comprises:
identifying a localized region corresponding to the one or more first-level collectors.

6. The method of claim 1 further comprising:
based on the results of the comparing, transmitting the event data that is received by the one or more first-level collectors to one or more second-level collectors upon determining by the cluster of first-level managers that the aggregate of the first reported attributes equals the aggregate of the second reported attributes.

7. The method of claim 6 wherein the event data transmitted to the one or more second-level collectors comprises at least a file or a container that contains event data for a plurality of events.

8. The method of claim 6 wherein the second-level collectors are fewer in number than the first-level collectors.

9. The method of claim 6 wherein at least one second-level collector receives event data from a plurality of the first-level collectors.

10. The method of claim 6 further comprising:
receiving, by a cluster of second-level managers, third reported attributes of event data that are transmitted to the one or more second-level collectors within a second time period;
receiving, by the cluster of second-level managers, fourth reported attributes of event data that are received by the one or more second-level collectors within the second time period; and
after the second time period, comparing by the cluster of second-level managers, an aggregate of the third reported attributes to an aggregate of the fourth reported attributes.

11. The method of claim 10 further comprising:
based on the results of the comparing, generating a second-level error message upon determining by the cluster of second-level managers that the aggregate of the third reported attributes do not equal the aggregate of the fourth reported attributes.

12. The method of claim 11 wherein generating the second-level error message further comprises:
identifying a localized region corresponding to the one or more second-level collectors.

13. The method of claim 11 further comprising:
based on the results of the comparing, transmitting the event data that is received by the one or more second-level collectors to a data warehouse upon determining by the cluster of second-level managers that the aggregate of the third reported attributes equals the aggregate of the fourth reported attributes.

14. The method of claim 10 wherein the second time period comprises a plurality of the first time periods.

15. The method of claim 10 wherein the first-level collectors and the second-level collectors together make a hierarchy.

16. The method of claim 10 wherein the first second period is sufficient to calculate the aggregate of the third reported attributes and the aggregate of the fourth reported attributes.

17. The method of claim 1 wherein the first time period is sufficient to calculate the aggregate of the first reported attributes and the aggregate of the second reported attributes.

18. A system for tracking event loss comprising:
one or more event generators that transmit event data corresponding to a plurality of events within a first time period and that report attributes of the event data transmitted within the first time period;
one or more first-level collectors that receive the transmitted event data within the first time period and report attributes of the event data received within the first time period; and
a cluster of first-level managers that compare the attributes of the event data transmitted within the first time period and the attributes of the event data received within the first time period, and based upon the comparison, signal transmission of the event data by the one or more first-level collectors.

19. The system of claim 18 wherein at least one of the cluster of first-level managers compares the attributes of the event data and at least a second of the cluster of first-level managers signals transmission of the event data.

20. The system of claim 18 further comprising:
one or more second-level collectors that receive event data transmitted by the one or more first-level collectors within a second time period and report attributes of the event data transmitted by the one or more first-level collectors within the second time period; and
a cluster of second-level managers that compare the attributes of the event data transmitted within the second time period and the attributes of the event data received within the second time period, and based upon the comparison, signal transmission of the event data to a data warehouse by the one or more second-level collectors.

21. The system of claim 20 wherein the first-level managers and the second-level managers communicate via a network.

22. The system of claim 20 wherein the cluster of second-level managers receive attributes of the event data from the cluster of first-level managers.
